(19) United States
(12) Patent Application Publication
(10) Pub. No.: US 2021/0352091 A1
(43) Pub. Date: Nov. 11, 2021

(54) ATTACK DETECTION DEVICE AND COMPUTER READABLE MEDIUM

(71) Applicant: MITSUBISHI ELECTRIC CORPORATION, Tokyo (JP)

(72) Inventor: Yuta Atobe, Tokyo (JP)

(73) Assignee: MITSUBISHI ELECTRIC CORPORATION, Tokyo (JP)

(21) Appl. No.: 17/379,306

(22) Filed: Jul. 19, 2021

Related U.S. Application Data
(63) Continuation of application No. PCT/JP2019/008881, filed on Mar. 6, 2019.

(51) Int. Cl. H04L 29/06

(52) U.S. Cl. CPC H04L 63/1416

(57) ABSTRACT

An execution control unit (110) confirms a transmission state of an external network (202). The execution control unit determines, as a request destination of attack judgment, either an attack judgment device (210) or an attack judgment unit (120), based on the transmission state of the external network. The execution control unit requests attack judgment to the request destination determined. Each of the attack judgment device and the attack judgment unit judges whether an attack against an in-vehicle system (100) exists, in response to a request of attack judgment.

### CROSS REFERENCE TO RELATED APPLICATIONS

This application is a Continuation of PCT International Application No. PCT/JP2019/008881, filed on Mar. 6, 2019, which is hereby expressly incorporated by reference into the present application.

### TECHNICAL FIELD

The present invention relates to a technique to detect an attack against an embedded system.

### BACKGROUND ART

Patent Literature 1 discloses a system to detect an attack against a vehicle. In this system, a cloud server detects an attack against a vehicle by collecting and analyzing a vehicle log.

This makes it possible to detect an attack with little consumption of vehicle resources.

### CITATION LIST

### Patent Literature

Patent Literature 1: WO 2017-104112 A

### SUMMARY OF INVENTION

### Technical Problem

In the system disclosed in Patent Literature 1, a cloud server detects an attack. Therefore, when a transmission state between a vehicle and the cloud server is poor, it becomes impossible to detect the attack.

Further, when attack detection is constantly performed by using resources of the vehicle, the resources of the vehicle are constantly consumed for attack detection. Therefore, processing for controlling the vehicle may be interfered.

The present invention is aimed at making it possible to continuously performing attack detection while suppressing processing loads applied to a vehicle for attack detection.

### Solution to Problem

An attack detection device according to one aspect of the present invention is included in an embedded system.

The attack detection device includes:

an attack judgment unit to judge whether an attack against the embedded system exists;

a transmission state confirmation unit to confirm a transmission state of an external network;

a request destination determination unit to determine, based on the transmission state of the external network, as a request destination of an attack judgment, either an attack judgment device that is provided outside the embedded system, to connect with the external network, or the attack judgment unit, and

an attack judgment request unit to request the attack judgment to the request destination determined.

### Advantageous Effects of Invention

According to the present invention, it is possible to determine a request destination of attack judgment according to a transmission state (transmission state of an external network) between a vehicle and a cloud server. Therefore, it is possible to continuously perform attack detection while suppressing processing loads applied to a vehicle for attack detection.

### BRIEF DESCRIPTION OF DRAWINGS

FIG. 1 is a configuration diagram of an attack detection system 200 according to a first embodiment;

FIG. 2 is a configuration diagram of an in-vehicle system 100 according to the first embodiment;

FIG. 3 is a flowchart of an execution control process according to the first embodiment;

FIG. 4 is a flowchart of an external request process (S104) according to the first embodiment;

FIG. 5 is a flowchart of an internal request process (S105) according to the first embodiment;

FIG. 6 is an explanatory drawing of an attack scenario according to the first embodiment;

FIG. 7 is a flowchart of an attack judgment method according to the first embodiment;

FIG. 8 is a flowchart of an attack way judgment according to the first embodiment;

FIG. 9 is a flowchart of an attack scenario judgment according to the first embodiment;

FIG. 10 is a flowchart of an execution control process according to a second embodiment;

FIG. 11 is a flowchart of an execution control process according to the second embodiment;

FIG. 12 is a flowchart of an execution control process according to the second embodiment;

FIG. 13 is a flowchart of an attack way judgment according to the second embodiment;

FIG. 14 is a flowchart of an attack scenario judgment according to the second embodiment;

FIG. 15 is a configuration diagram of an execution control unit 110 according to a third embodiment;

FIG. 16 is a flowchart of an execution control process according to the third embodiment;

FIG. 17 is a flowchart of an attack judgment method according to the third embodiment;

FIG. 18 is a configuration diagram of an execution control unit 110 according to a fourth embodiment;

FIG. 19 is a flowchart of an execution control process according to the fourth embodiment;

FIG. 20 is a configuration diagram of an execution control unit 110 according to a fifth embodiment;

FIG. 21 is a flowchart of an execution control process according to the fifth embodiment;

FIG. 22 is a flowchart of an attack way judgment according to the fifth embodiment;

FIG. 23 is a diagram illustrating an attack way list 191 according to the fifth embodiment;

FIG. 24 is a flowchart of an attack scenario judgment according to the fifth embodiment;

FIG. 25 is a diagram illustrating an attack scenario list 192 according to the fifth embodiment; and

FIG. 26 is a configuration diagram of hardware of an in-vehicle system 100 according to the embodiments.

### DESCRIPTION OF EMBODIMENTS

In embodiments and diagrams, same elements or corresponding elements are denoted by same signs. The explanation of the elements denoted by the same signs as the elements that have been explained will be appropriately omitted or simplified. Arrows in the diagrams illustrate flows of data or flows of processes.

### First Embodiment

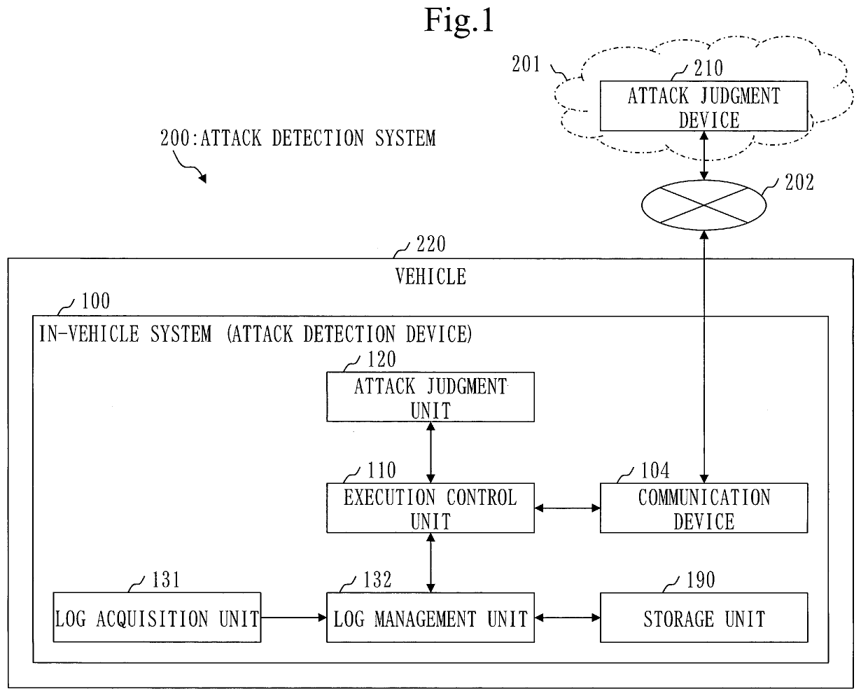

An attack detection system 200 will be described based on FIG. 1 through FIG. 9.

***Description of Configuration***

Based on FIG. 1, a configuration of the attack detection system 200 will be described.

The attack detection system 200 includes an attack judgment device 210 and a vehicle 220.

The attack judgment device 210 is a device to judge whether a cyberattack exists, which is placed in a cloud 201.

The vehicle 220 is equipped with an in-vehicle system 100.

The in-vehicle system 100 is an embedded system mounted on the vehicle 220.

A part of the in-vehicle system 100 functions as an “attack detection device.”

The “attack detection device” is a device to detect a cyberattack against the in-vehicle system 100.

An external network 202 is a communication network external to the in-vehicle system 100. The attack judgment device 210 is connected to the external network 202. For example, the external network 202 is the internet.

Meanwhile, a communication network inside the in-vehicle system 100 is referred to as an “in-vehicle network” or an “internal network.” For example, the in-vehicle network is a controller area network (CAN).

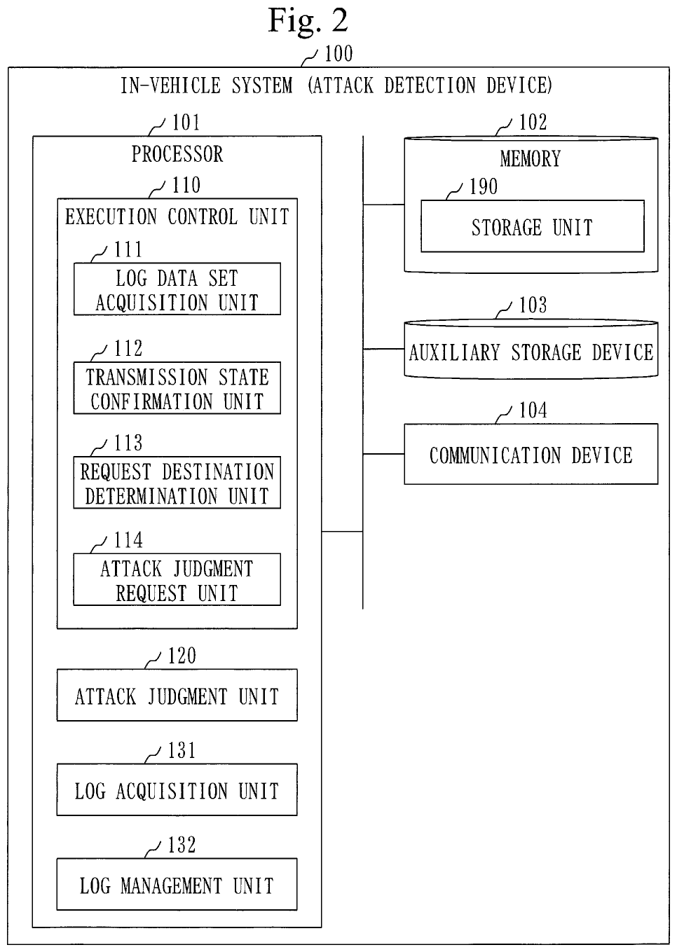

Based on FIG. 2, a configuration of the attack detection device of the in-vehicle system 100 will be described.

The in-vehicle system 100 is a computer equipped with hardware components such as a processor 101, a memory 102, an auxiliary storage device 103 and a communication device 104. These hardware components are connected to one another via a signal line.

The processor 101 is an IC to perform arithmetic processing, which controls other hardware components. For example, the processor 101 is a CPU.

“IC” is an abbreviation for integrated circuit.

“CPU” is an abbreviation for central processing unit.

The memory 102 is a volatile storage device. The memory 102 is also referred to as a main storage device or main memory. For example, the memory 102 is RAM. Data stored in the memory 102 is stored in the auxiliary storage device 103 as needed.

“RAM” is an abbreviation for random-access memory.

The auxiliary storage device 103 is a non-volatile storage device. For example, the auxiliary storage device 103 is ROM, a HDD or flash memory. Data stored in the auxiliary storage device 103 is loaded into the memory 102 as needed.

“ROM” is an abbreviation for “read-only memory.”

“HDD” is an abbreviation for “hard disk drive.”

The communication device 104 is a receiver and a transmitter, which is connected to the external network 202. For example, the communication device 104 is a communication chip or a NIC.

“NIC” is an abbreviation for “network interface card.”

The in-vehicle system 100 is equipped with elements such as an execution control unit 110, an attack judgment unit 120, a log acquisition unit 131 and a log management unit 132. These elements are realized by software.

The execution control unit 110 is equipped with a log data set acquisition unit 111, a transmission state confirmation unit 112, a request destination determination unit 113 and an attack judgment request unit 114.

The auxiliary storage device 103 stores an attack detection program to make a computer function as the execution control unit 110, the attack judgment unit 120, the log acquisition unit 131 and the log management unit 132. The attack detection program is loaded into the memory 102, and executed by the processor 101.

The auxiliary storage device 103 further stores an OS. At least a part of the OS is loaded into the memory 102, and executed by the processor 101.

The processor 101 executes the attack detection program while executing the OS.

“OS” is an abbreviation for “operating system.”

Input and output data of the attack detection program is stored in a storage unit 190.

The memory 102 functions as the storage unit 190. However, storage devices such as the auxiliary storage device 103, a register inside the processor 101 and cache memory inside the processor 101 may function as the storage unit 190 on behalf of the memory 102, or together with the memory 102.

The in-vehicle system 100 may include a plurality of processors replacing the processor 101. The plurality of processors share roles of the processor 101.

It is possible to record (store) the attack detection program in a computer-readable manner in a non-volatile record medium such as an optical disk or flash memory, etc.

***Description of Operations***

An operation of the attack detection device in the in-vehicle system 100 corresponds to an attack detection method. Further, a procedure of the attack detection method corresponds to a procedure of an attack detection program.

The process of the attack detection method will be described below.

First, functions of the log acquisition unit 131 and the log management unit 132 will be described respectively.

The log acquisition unit 131 acquires log data indicating events that have occurred in the in-vehicle system 100. For example, the log acquisition unit 131 acquires log data of communication log, process log and authentication log, etc.

The log management unit 132 stores the log data acquired in the storage unit 190, and manages the log data stored.

For example, the log management unit 132 adds a log identifier to each piece of log data. The log identifier is an identifier to uniquely identify each piece of log data.

For instance, the log management unit 132 adds a processed tag to log data used for attack judgment. Furthermore, for example, the log management unit 132 adds a transmitted tag to log data that has been transmitted when the log data has been transmitted to the attack judgment device 210, and an attack judgment result is returned from the attack judgment device 210. In addition, for example, the log management unit 132 adds an undeletable tag to log data for which an undeletable instruction has been issued from the attack judgment device 210.

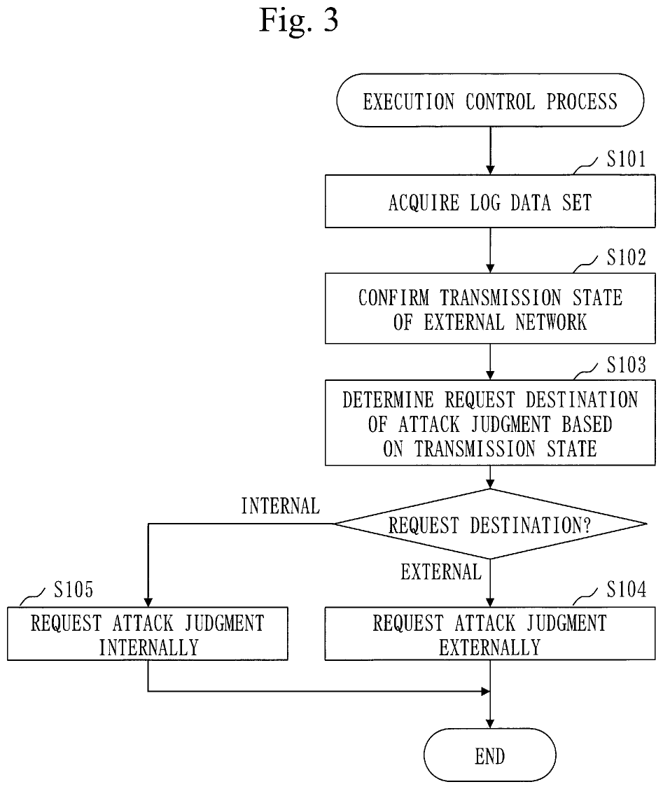

Based on FIG. 3, a process (execution control process) of the execution control unit 110 will be described.

The execution control process is performed on a regular basis or at an arbitrary time.

In a step S101, the log data set acquisition unit 111 acquires a log data set.

The log data set is one or more pieces of log data used for attack judgment.

The log data set acquisition unit 111 acquires the log data set in the following manner.

First, the log data set acquisition unit 111 requests a log data set to the log management unit 132.

Next, the log management unit 132 selects all pieces of log data whereto a processed tag has not been added, from the storage unit 190.

Next, the log management unit 132 notifies the log data set acquisition unit 111 of all the pieces of log data selected.

Then, the log data set acquisition unit 111 receives all the pieces of log data selected.

Further, the log management unit 132 adds a processed tag to all the pieces of log data selected.

In a step S102, the transmission state confirmation unit 112 confirms a transmission state of the external network 202.

The transmission state confirmation unit 112 confirms the transmission state of the external network 202 in the following manner.

The communication device 104 manages connection status information to the external network 202.

The transmission state confirmation unit 112 acquires connection status information to the external network 202.

The connection status information indicates a connection status with a communication network.

For example, the connection status information indicates connection statuses such as “connected,” “processing connection,” “processing authentication,” “acquiring connection information,” “checking connection,” “interrupting connection,” “processing disconnection,” or “disconnected.”

The rest of the connection statuses except “connected” and “disconnected” are referred to as “intermediate status.”

“Connected,” “disconnected” and “intermediate status” specify the degree of quality of the transmission state. “Connected” corresponds to a transmission state of “good.” “Disconnected” corresponds to a transmission state of “bad.” “Intermediate status” corresponds to a transmission state of “normal.”

The transmission state may be specified by information different from the connection status.

For example, the transmission state may be specified by radio field intensity, throughput, disconnection time or continuous communication time.

In a step S103, the request destination determination unit 113 determines a request destination of attack judgment based on the transmission state of the external network 202.

For example, when the connection status with the external network 202 is “connected,” the request destination determination unit 113 determines a request destination of attack judgment as the attack judgment device 210.

For example, when the connection status with the external network 202 is not “connected,” the request destination determination unit 113 determines a request destination of attack judgment as the attack judgment unit 120.

When the request destination of attack judgment is the attack judgment device 210 (external), the processing proceeds to a step S104.

When the request destination of attack judgment is the attack judgment unit 120 (internal), the processing proceeds to a step S105.

In the step S104, the attack judgment request unit 114 requests attack judgment to the attack judgment device 210.

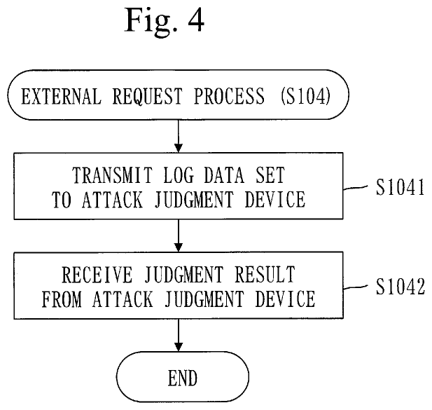

Based on FIG. 4, an external request process (S104) will be described.

In a step S1041, the attack judgment request unit 114 transmits a log data set to the attack judgment device 210 using the communication device 104.

The attack judgment device 210 receives the log data set, performs attack judgment based on the log data set, and transmits a judgment result.

The method of attack judgment will be described later.

In a step S1042, the attack judgment request unit 114 receives the judgment result from the attack judgment device 210 using the communication device 104.

Returning to FIG. 3, the step S105 will be described.

In the step S105, the attack judgment request unit 114 requests attack judgment to the attack judgment unit 120.

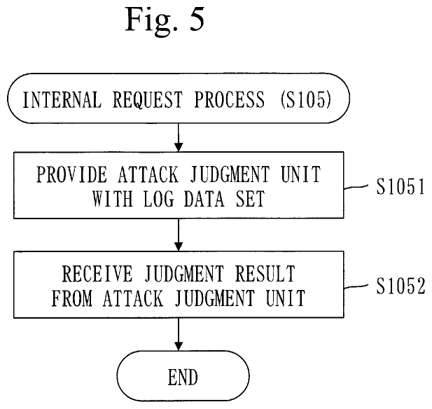

Based on FIG. 5, the procedure of an internal request process (S105) will be described.

In a step S1051, the attack judgment request unit 114 provides a log data set with the attack judgment unit 120.

The attack judgment unit 120 receives the log data set, performs attack judgment based on the log data set, and gives notice of a judgment result.

The method of attack judgment will be described later.

In the step S1052, the attack judgment request unit 114 receives the judgment result from the attack judgment unit 120.

An attack judgment method will be described below.

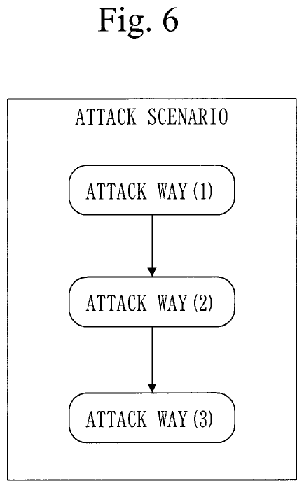

Based on FIG. 6, an attack scenario will be described.

The attack scenario indicates a series of attack ways constituting a cyberattack. The attack scenario in FIG. 6 indicates a cyberattack constituted by three attack ways.

An attack way is an element of the cyberattack, which is also referred to as an attack phase.

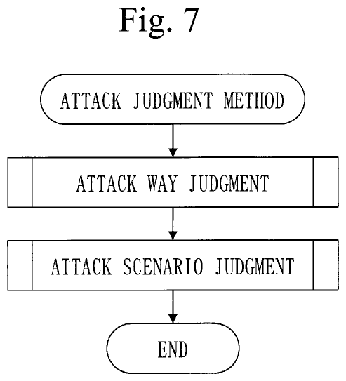

Based on FIG. 7, the procedure of the attack judgment method will be described.

In the attack judgment method, processes such as an attack way judgment and am attack scenario judgment are performed.

The attack way judgment is a process to judge whether log data that matches each of one or more attack ways is included in the log data set.

The attack scenario judgment is a process to judge whether a log data group that matches each of one or more attack scenarios is included in the log data set.

That is, the attack scenario judgment is a process to check a relation of the attack way judged in the attack way judgment based on a generation source or a generation factor of a log, etc., and judges whether the relation checked matches each of the one or more attack scenarios.

In other words, the attack scenario judgment is a process to judge whether the one or more attack ways that match each of the one or more attack scenarios and the relation of the one or more attack ways are included in the result of checking the relation of the attack way judged in the attack way judgment. Further, in the attack scenario judgment, it may be applicable to check a relation between an attack way and log data, and judge whether the relation checked matches each of the one or more attack scenarios.

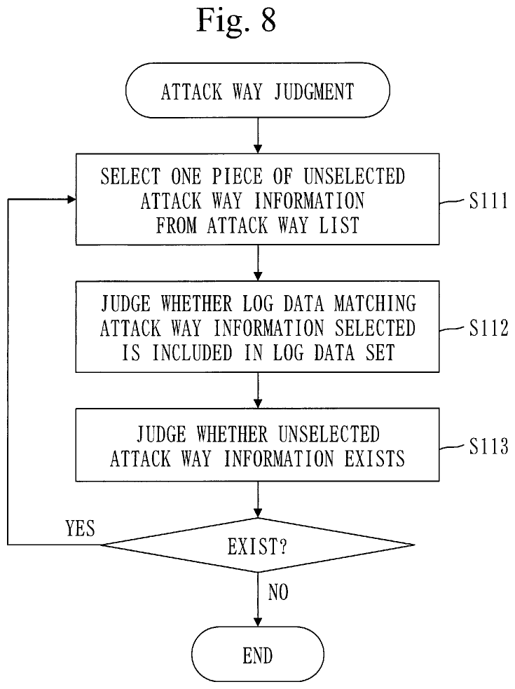

Based on FIG. 8, an attack way judgment by the attack judgment unit 120 will be described.

The attack way judgment by the attack judgment device 210 is the same as the attack way judgment by the attack judgment unit 120.

In a step S111, the attack judgment unit 120 selects one piece of unselected attack way information from an attack way list.

The attack way list indicates one or more pieces of attack way information, which is stored in the storage unit 190 beforehand.

The attack way information is information to specify an attack way.

In a step S112, the attack judgment unit 120 judges whether log data that matches attack way information selected is included in the log data set.

For example, the attack judgment unit 120 performs pattern matching of each piece of log data of the log data set with attack way information.

In a step S113, the attack judgment unit 120 judges whether unselected attack way information exists.

When unselected attack way information exists, the processing proceeds to the step S111.

When unselected attack way information does not exist, the attack way judgment ends.

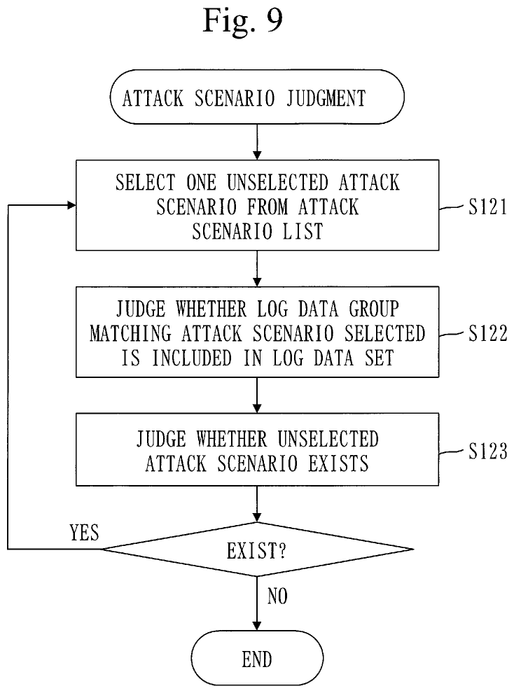

Based on FIG. 9, an attack scenario judgment by the attack judgment unit 120 will be described.

The attack scenario judgment by the attack judgment device 210 is the same as the attack scenario judgment by the attack judgment unit 120.

In a step S121, the attack judgment unit 120 selects one unselected attack scenario from the attack scenario list.

The attack scenario list indicates one or more attack scenarios, which is stored in the storage unit 190 beforehand.

In a step S122, the attack judgment unit 120 judges whether a log data group that matches the attack scenario selected is included in the log data set based on the result of the attack way judgment.

Specifically, the attack judgment unit 120 checks a relation of the attack way judged in the attack way judgment based on a generation source or a generation factor of a log, etc., and judges whether the relation checked matches each of the one or more attack scenarios.

In other words, the attack judgment unit 120 judges whether one or more attack ways that match each of the one or more attack scenarios and the relation of the one or more attack ways are included in the result of checking the relation of the attack way judged in the attack way judgment. Further, the attack judgment unit 120 may check the relation between an attack way and log data, and judge whether the relation checked matches each of the one or more attack scenarios.

For example, an attack scenario in FIG. 6 indicates a cyberattack, to attack in an attack way (1), an attack way (2) and an attack way (3).

Log data that matches information on the attack way (1) is called log data (1). Log data that matches information on the attack way (2) is called log data (2). Log data that matches information on the attack way (3) is called log data (3).

When an alignment sequence (chronological order of events) of the log data (1), (2) and (3) is the log data (1), the log data (2) and the log data (3), the log data (1), (2) and (3) match the attack scenario in FIG. 5.

In a step S123, the attack judgment unit 120 judges whether an unselected attack scenario exists.

When an unselected attack scenario exists, the processing proceeds to the step S121.

When an unselected attack scenario does not exist, the attack scenario judgment ends.

***Effect of First Embodiment***

By the first embodiment, it is possible to determine a request destination of attack judgment in response to a transmission state of the external network 202. Therefore, it is possible to perform attack detection continuously while suppressing a processing load applied to the in-vehicle system 100 for attack detection.

### Second Embodiment

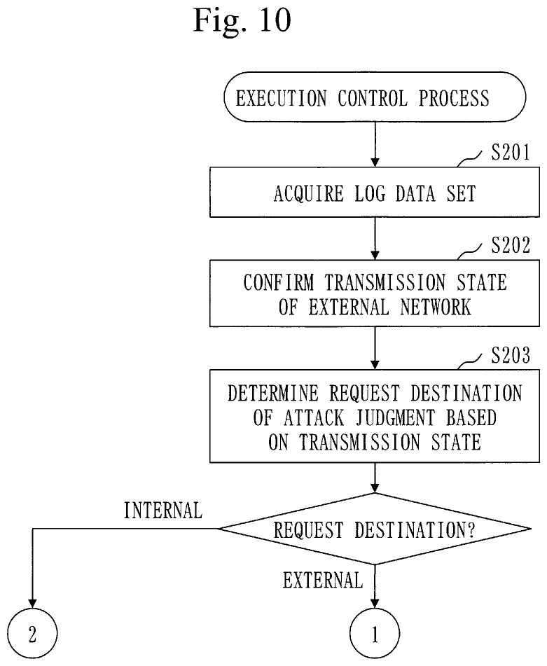

With respect to an embodiment handling change in a transmission state, points different from the first embodiment will be mainly describe based on FIG. 10 through FIG. 14.

***Explanation of Configuration*** A configuration of an attack detection system 200 is the same as the configuration in the first embodiment (refer to FIG. 1 and FIG. 2).

***Explanation of Operation***

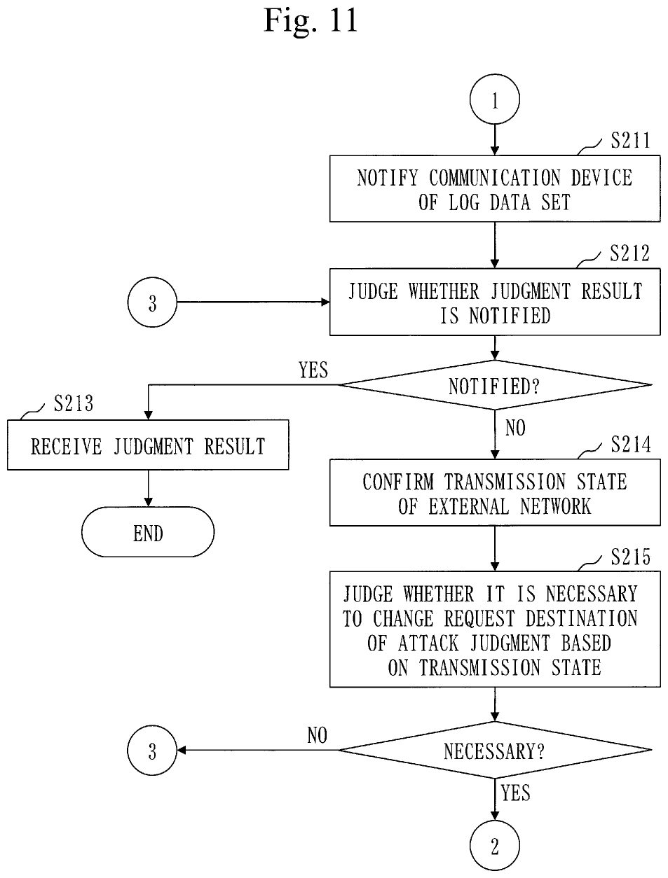

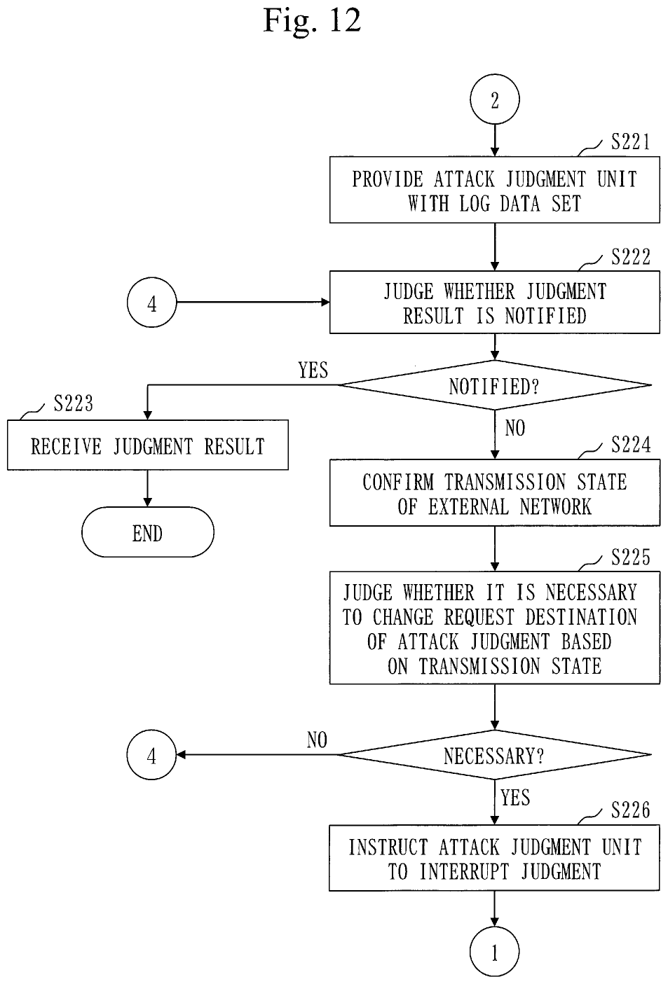

Based on FIG. 10, FIG. 11 and FIG. 12, an execution control process will be described.

In a step S201, the log data set acquisition unit 111 acquires a log data set.

The step S201 is the same as the step S101 in the first embodiment.

In a step S202, the transmission state confirmation unit 112 confirms a transmission state of the external network 202.

The step S202 is the same as the step S102 in the first embodiment.

In a step S203, the request destination determination unit 113 determines a request destination of attack judgment based on a transmission state of the external network 202.

The step S203 is the same as the step S103 in the first embodiment.

When the request destination of the attack judgment is the attack judgment device 210 (external), the processing proceeds to a step S211.

When the request destination of attack judgment is the attack judgment unit 120 (internal), the processing proceeds to a step S221.

In a step S211, the attack judgment request unit 114 notifies the communication device 104 of the log data set.

The communication device 104 transmits the log data set to the attack judgment device 210.

The attack judgment device 210 receives the log data set, and performs attack judgment based on the log data set.

When attack judgment is completed, the attack judgment device 210 transmits a judgment result. The communication device 104 receives the judgment result, and notifies the attack judgment request unit 114 of the judgment result.

In a step S212, the attack judgment request unit 114 judges whether the judgment result has been notified from the communication device 104.

When the judgment result has been notified, the processing proceeds to a step S213.

When the judgment result has not been notified, the processing proceeds to a step S214.

In the step S213, the attack judgment request unit 114 receives the judgment result notified.

In a step S214, the transmission state confirmation unit 112 confirms a transmission state of the external network 202.

The step S214 is the same as the step S102 in the first embodiment.

In a step S215, the request destination determination unit 113 judges whether it is necessary to change a request destination of attack judgment based on a transmission state of the external network 202.

For example, when a connection status with the external network 202 changes from “connected” to a state other than “connected,” the request destination determination unit 113 judges that it is necessary to change the request destination of attack judgment.

For example, when the connection status with the external network 202 does not change, remaining to be “connected,” the request destination determination unit 113 judges that it is unnecessary to change attack judgment.

When it is judged to be necessary to change a request destination of attack judgment, the processing proceeds to a step S221.

When it is judged to be unnecessary to change a request destination of attack judgment, the processing proceeds to a step S212.

In the step S221, the attack judgment request unit 114 provides the attack judgment unit 120 with a log data set.

The attack judgment unit 120 receives the log data set, and performs attack judgment based on the log data set.

When the attack judgment is completed, the attack judgment unit 120 gives notice of a judgment result.

In a step S222, the attack judgment request unit 114 judges whether the judgment result is notified from the attack judgment unit 120.

When the judgment result is notified, the processing proceeds to a step S223.

When the judgment result is not notified, the processing proceeds to a step S224.

In the step S223, the attack judgment request unit 114 receives the judgment result.

In the step S224, the transmission state confirmation unit 112 confirms a transmission state of the external network 202.

The step S224 is the same as the step S102 in the first embodiment.

In a step S225, the request destination determination unit 113 judges whether it is necessary to change a request destination of attack judgment based on the transmission state of the external network 202.

For example, when the connection status with the external network 202 changes from a state other than “connected” to “connected,” the request destination determination unit 113 judges that it is necessary to change the request destination of attack judgment.

For example, when the connection status with the external network 202 does not change, remaining to be a state other than “connected,” the request destination determination unit 113 judges that it is unnecessary to change attack judgment.

When it is judged to be necessary to change the request destination of attack judgment, the processing proceeds to a step S226.

When it is judged to be unnecessary to change the request destination of attack judgment, the processing proceeds to a step S222.

In the step S226, the attack judgment request unit 114 instructs the attack judgment unit 120 to interrupt attack judgment.

When interruption of attack judgment is instructed, the attack judgment unit 120 interrupts attack judgment.

After the step S226, the procedure proceeds to the step S211.

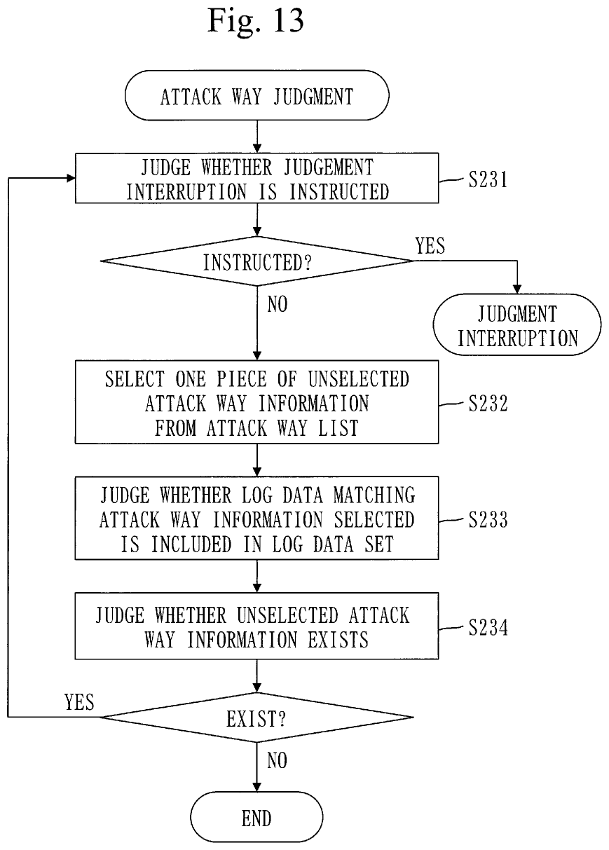

Based on FIG. 13, an attack way judgment by the attack judgment unit 120 will be described.

In a step S231, the attack judgment unit 120 judges whether judgment interruption is instructed.

When judgment interruption is instructed, the attack judgment unit 120 interrupts attack judgment.

When judgment interruption is not instructed, the procedure proceeds to a step S232.

The step S232 through a step S234 are the same as the processing (S111 through S113) in the first embodiment.

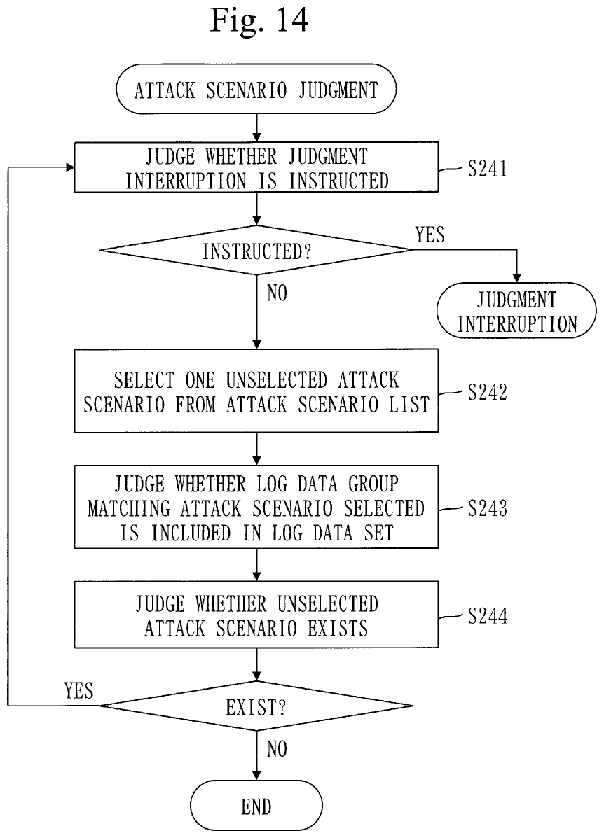

Based on FIG. 14, an attack scenario judgment by the attack judgment unit 120 will be described.

In a step S241, the attack judgment unit 120 judges whether judgment interruption is instructed.

When judgment interruption is instructed, the attack judgment unit 120 interrupts attack judgment.

When judgment interruption is not instructed, the processing proceeds to a step S242.

The step S242 through a step S244 are the same as the processing (S121 through S123) in the first embodiment.

***Effect of Second Embodiment***

By the second embodiment, it is possible to respond to change in a transmission state.

Specifically, it is possible to obtain a judgment result from the attack judgment unit 120, even when a transmission state gets worse since when attack judgment is requested to the attack judgment device 210 until when a judgment result is received from the attack judgment device 210. That is, even when a transmission state changes, it is possible to perform attack detection continuously.

Further, when a transmission state gets better since when attack judgment is requested to the attack judgment unit 120 until when a judgment result is received from the attack judgment unit 120, it is possible to interrupt attack judgment by the attack judgment unit 120, and obtain a judgment result from the attack judgment device 210. Therefore, it is possible to reduce the processing load applied to the in-vehicle system 100 for attack detection.

***Supplement to Second Embodiment***

When a request destination of attack judgment is changed, it may be applicable for the attack judgment request unit 114 to receive, from an old request destination, a judgment result (partial result) obtained by processing that has been performed of the attack judgment, and to inform a new request destination of the partial result. The new request destination receives the partial result, and performs processing after processing that has been performed.

### Third Embodiment

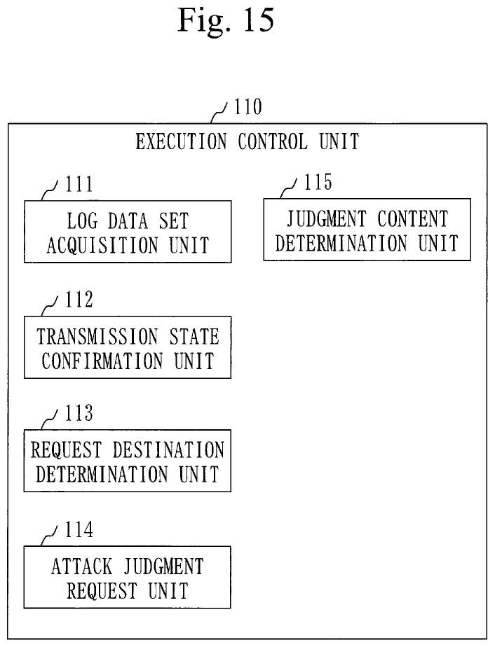

As for an embodiment wherein a judgment content is controlled in accordance with a transmission state, parts different from the first embodiment will be mainly described based on FIG. 15 through FIG. 17.

***Description of Configuration***

The configuration of the attack detection system 200 is the same as the configuration in the first embodiment except a configuration of an execution control unit 110 (refer to FIG. 1 and FIG. 2).

A configuration of the execution control unit 110 will be described based on FIG. 15.

The execution control unit 110 is equipped with a judgment content determination unit 115.

The other configurations are the same as the configurations in the first embodiment.

***Explanation of Operations***

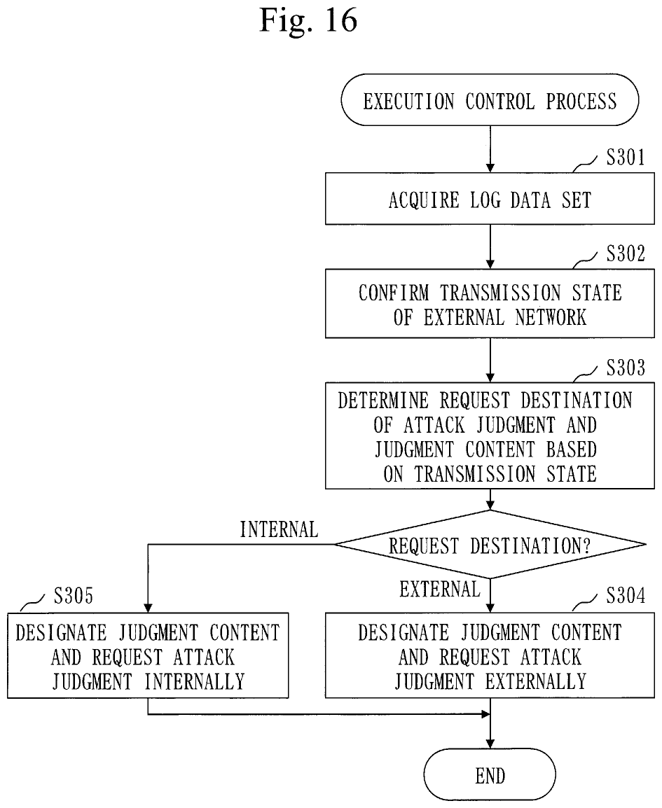

An execution control process will be described based on FIG. 16.

In a step S301, the log data set acquisition unit 111 acquires a log data set.

The step S301 is the same as the step S101 in the first embodiment.

In a step S302, the transmission state confirmation unit 112 confirms a transmission state of the external network 202.

The step S302 is the same as the step S102 in the first embodiment.

In a step S303, the request destination determination unit 113 determines a request destination of attack judgment based on a transmission state of the external network 202.

A method to determine a request destination of attack judgment is the same as the method in the step S103 in the first embodiment.

The judgment content determination unit 115 determines a judgment content based on a transmission state of the external network 202.

For example, the judgment content determination unit 115 determines each judgment content of an attack way judgment and an attack scenario judgment as follows.

When a connection status with the external network 202 is “connected” or “disconnected,” the judgment content determination unit 115 determines each judgment content of the attack way judgment and the attack scenario judgment as a “total judgment.” The “total judgment” is an attack judgment performed for all pieces of attack way information registered in the attack way list, and all of an attack scenario registered in the attack scenario list.

When a connection status with the external network 202 is “intermediate status,” the judgment content determination unit 115 determines each judgment content of the attack way judgment and the attack scenario judgment as a “partial judgment.” The “partial judgment” is an attack judgment performed for a partial piece of attack way information registered in the attack way list, and a part of the attack scenario registered in the attack scenario.

When a request destination of attack judgment is the attack judgment device 210 (external), the processing proceeds to a step S304.

When a request destination of attack judgment is the attack judgment unit 120 (internal), the processing proceeds to a step S305.

In the step S304, the attack judgment request unit 114 designates a judgment content and requests attack judgment to the attack judgment device 210.

In the step S305, the attack judgment request unit 114 designates a judgment content, and requests attack judgment to the attack judgment unit 120.

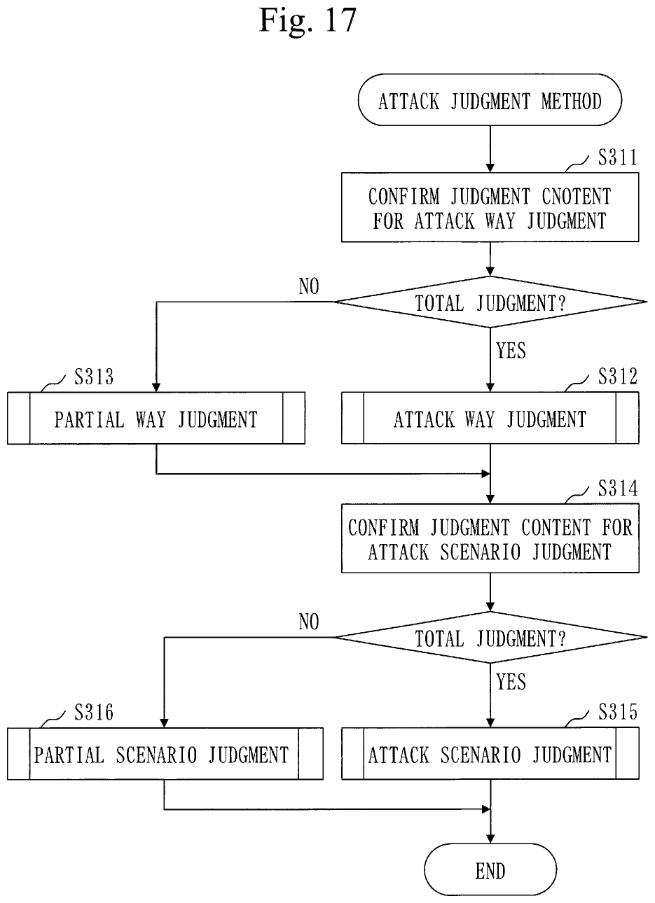

Based on FIG. 17, an attack judgment by the attack judgment unit 120 will be described.

The attack judgment by the attack judgment device 210 is the same as the attack judgment by the attack judgment unit 120.

In a step S311, the attack judgment unit 120 confirms a judgment content for an attack way judgment.

When the judgment content is a “total judgment,” the processing proceeds to a step S312.

When the judgment content is a “partial judgment,” the processing proceeds to a step S313.

In the step S312, the attack judgment unit 120 performs attack way judgment.

The attack way judgment is just as what described in the first embodiment (refer to FIG. 8).

In the step S313, the attack judgment unit 120 performs a partial way judgment.

The partial way judgment is an attack way judgment to be performed for the partial piece of attack way information registered in the attack way list.

For example, the attack judgment unit 120 performs attack way judgment using a partial way list instead of the attack way list. The partial way list indicates the partial piece of attack way information registered in the attack way list, which is stored in the storage unit 190 beforehand.

In a step S314, the attack judgment unit 120 confirms a judgment content for an attack scenario judgment.

When the judgment content is a “total judgment,” the processing proceeds to a step S315.

When the judgment content is not a “partial judgment,” the processing proceeds to a step S316.

In the step S315, the attack judgment unit 120 performs attack scenario judgment.

The attack scenario judgment is just as what described in the first embodiment (refer to FIG. 9).

In the step S316, the attack judgment unit 120 performs a partial scenario judgment.

The partial scenario judgment is an attack scenario judgment performed for the partial piece of attack scenario information registered in the attack scenario list.

For example, the attack judgment unit 120 performs attack scenario judgment using the partial scenario list instead of the attack scenario list. The partial scenario list indicates the partial piece of attack scenario information registered in the attack scenario list, which is stored in the storage unit 190 beforehand.

***Effect of Third Embodiment***

By the third embodiment, it is possible to control a judgment content in accordance with a transmission state. Therefore, it is possible to continue at least a part of attack detection irrespective of the transmission state.

***Supplement to Third Embodiment***

The third embodiment may be performed in combination with the second embodiment. That is, in the third embodiment, the attack judgment request unit 114 may change a request destination of attack judgment in accordance with change in the transmission state.

### Fourth Embodiment

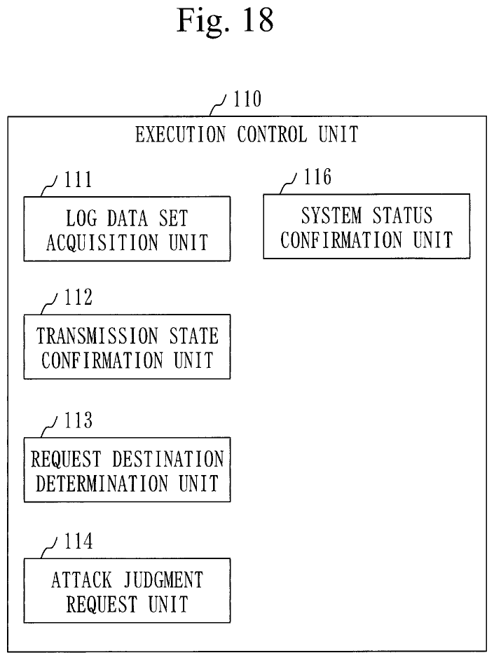

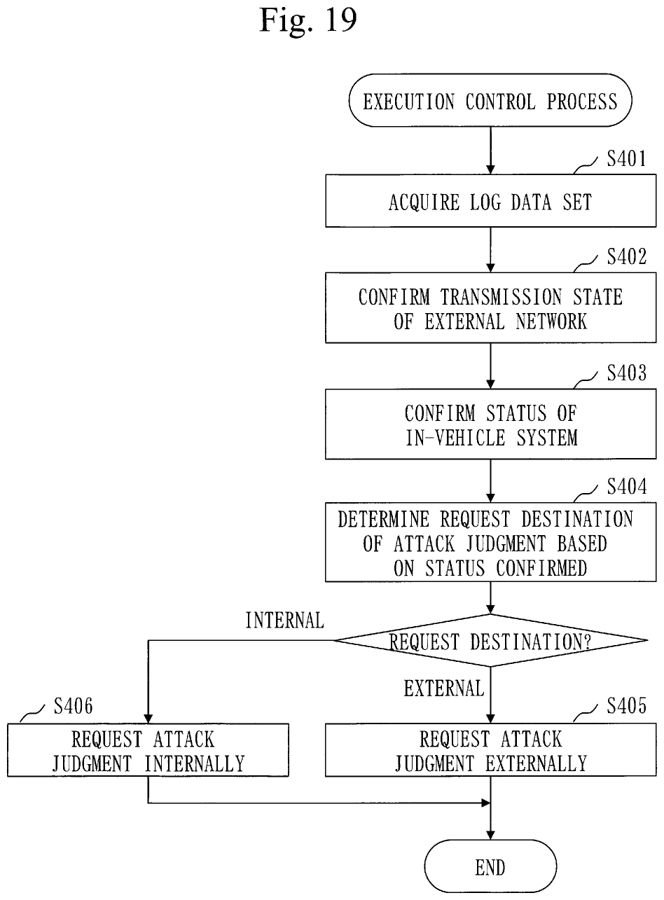

With respect to an embodiment wherein a request destination of attack judgment is determined in consideration of a system status, points different from the first embodiment will be mainly described based on FIG. 18 and FIG. 19.

***Explanation of Configuration***

A configuration of the attack detection system 200 is the same as the configuration in first embodiment except the configuration of the execution control unit 110 (refer to FIG. 1 and FIG. 2).

Based on FIG. 18, the configuration of the execution control unit 110 will be described.

The execution control unit 110 is equipped with a system status confirmation unit 116.

The other configuration is the same as the configuration in the first embodiment.

***Explanation of Operation***

Based on FIG. 19, an execution control process will be described.

In a step S401, the log data set acquisition unit 111 acquires a log data set.

The step S401 is the same as the step S101 in the first embodiment.

In a step S402, the transmission state confirmation unit 112 confirms a transmission state of an external network 202.

The step S402 is the same as the step S102 in the first embodiment.

In a step S403, the system status confirmation unit 116 confirms a status (system status) of the in-vehicle system 100.

For example, the system status confirmation unit 116 confirms a load status in the in-vehicle system 100. The load status in the in-vehicle system 100 is specified by a utilization rate of the processor 101, a free time of the processor 101, a utilization rate of the memory 102 and a free space of the processor 101, etc.

For instance, the system status confirmation unit 116 confirms a traveling status of the vehicle 220 on which the in-vehicle system 100 is mounted. The traveling status of the vehicle 220 is specified by traveling or stopping, etc.

In a step S404, the request destination determination unit 113 determines a request destination of attack judgment based on the status confirmed.

For example, the request destination determination unit 113 determines a request destination of attack judgment as follows.

When a connection status with the external network 202 is “connected,” the request destination determination unit 113 determines the attack judgment device 210 as a request destination of attack judgment.

When a connection status with the external network 202 is “disconnected,” the request destination determination unit 113 determines the attack judgment unit 120 as a request destination of attack judgment.

When a connection status with the external network 202 is “intermediate status” and a load status of the in-vehicle system 100 is “low load,” the request destination determination unit 113 determines the attack judgment unit 120 as a request destination of attack judgment.

When a connection status with the external network 202 is “intermediate status” and a load status of the in-vehicle system 100 is “high load,” and further, a traveling status of the vehicle 220 is “traveling,” the request destination determination unit 113 determines the attack judgment unit 120 as a request destination of attack judgment.

When a connection status with the external network 202 is “intermediate status” and a load status of the in-vehicle system 100 is “high load,” and further, a traveling status of the vehicle 220 is “stopping,” the request destination determination unit 113 determines the attack judgment device 210 as a request destination of attack judgment.

When the request destination of attack judgment is the attack judgment device 210 (external), the processing proceeds to a step S405.

When the request destination of attack judgment is the attack judgment unit 120 (internal), the processing proceeds to a step S406.

In the step S405, the attack judgment request unit 114 requests attack judgment to the attack judgment device 210.

The step S405 is the same as the step S104 in the first embodiment.

In the step S406, the attack judgment request unit 114 requests attack judgment to the attack judgment unit 120.

The step S406 is the same as the step S105 in the first embodiment.

***Effect of Fourth Embodiment***

By the fourth embodiment, it is possible to determine a request destination of attack judgment in consideration of a system status. Therefore, it is possible to determine a request destination of attack judgment more suitably.

***Supplement to Fourth Embodiment***

The fourth embodiment may be performed in combination with the second embodiment. That is, in the fourth embodiment, the attack judgment request unit 114 may change a request destination of attack judgment in accordance with change in a transmission state.

The fourth embodiment may be performed in combination with the third embodiment. That is, in the fourth embodiment, the execution control unit 110 may be equipped with the judgment content determination unit 115.

### Fifth Embodiment

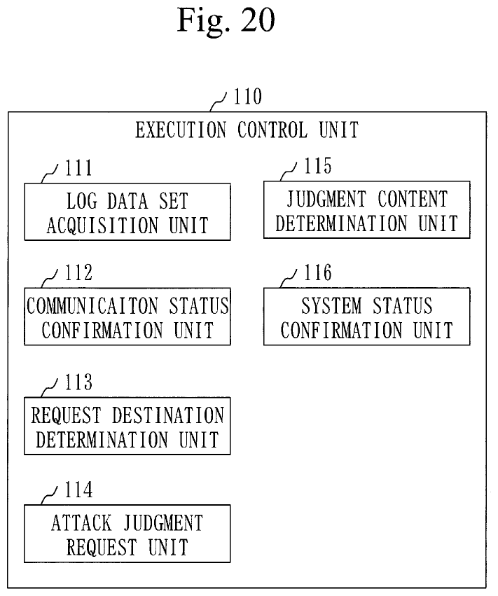

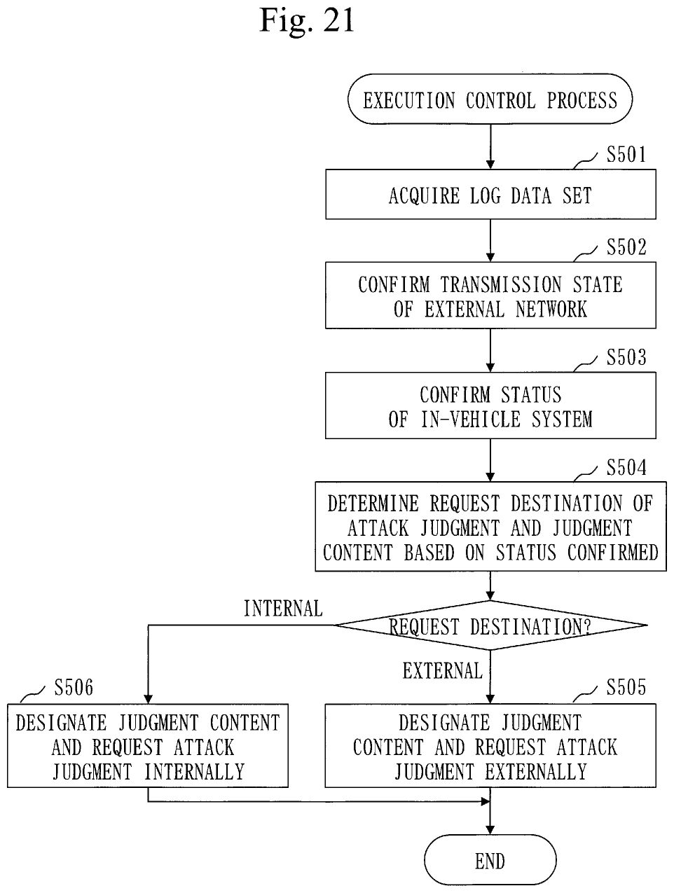

With respect to an embodiment wherein a judgment content is controlled in consideration of a system status, points different from the third embodiment will be mainly described based on FIG. 20 through FIG. 25.

***Explanation of Configuration***

The configuration of the attack detection system 200 is the same as the configuration in the first embodiment except the configuration of the execution control unit 110 (refer to FIG. 1 and FIG. 2).

The configuration of the execution control unit 110 will be described based on FIG. 20.

The execution control unit 110 is equipped with the system status confirmation unit 116.

The other configuration is the same as the configuration in the third embodiment (refer to FIG. 15).

***Explanation of Operation***

An execution control process will be described based on FIG. 19.

In a step S501, the log data set acquisition unit 111 acquires a log data set.

The step S501 is the same as the step S101 in the first embodiment.

In a step S502, the transmission state confirmation unit 112 confirms a transmission state of the external network 202.

The step S502 is the same as the step S102 in the first embodiment.

In a step S503, the system status confirmation unit 116 confirms a status (system status) of the in-vehicle system 100.

The step S503 is the same as the step S403 in the third embodiment.

In a step S504, the request destination determination unit 113 determines a request destination of attack judgment based on a transmission state of the external network 202.

A method to determine a request destination of attack judgment is the same as the method in the step S103 in the first embodiment.

However, the request destination determination unit 113 may determine a request destination of attack judgment in consideration of a status other than the transmission state, similarly as in the step S404 in the fourth embodiment.

The judgment content determination unit 115 determines a judgment content based on the status confirmed.

For example, the judgment content determination unit 115 calculates a priority threshold value to specify a judgment content based on the status confirmed.

For example, the judgment content determination unit 115 calculates a priority threshold value by calculating a formula (1).

max (X, Y) means selecting a larger one from “X” and “Y.”

“α₁” “β₁” “α₂” “β₂” are values determined beforehand.

A CPU load is a value representing a size of the load of the processor 101.

A traveling status degree is a value calculated by using velocity of the vehicle 220, a steering angle of the vehicle 220 and acceleration of the vehicle 220, etc.

Priority threshold value=max(load status threshold value,traveling status threshold value) (1)

Load status threshold value=α₁*CPU load+β1

Traveling status threshold value=α₂*Traveling status degree+β₂

When the request destination of attack judgment is the attack judgment device 210 (external), the processing proceeds to a step S505.

When the request destination of attack judgment is the attack judgment unit 120 (internal), the processing proceeds to a step S506.

In the step S505, the attack judgment request unit 114 designates a judgment content, and requests attack judgment to the attack judgment device 210.

The attack judgment device 210 performs attack judgment in accordance with the judgment content designated. For example, the attack judgment device 210 performs attack judgment similarly as in the processing in the third embodiment (refer to FIG. 17).

In the step S506, the attack judgment request unit 114 designates a judgment content, and requests attack judgment to the attack judgment unit 120.

The attack judgment unit 120 performs attack judgment in accordance with the judgment content designated. For example, the attack judgment unit 120 performs attack judgment similarly as in the processing in the third embodiment (refer to FIG. 17).

It will be hereinafter described attack judgment in a case wherein a judgment content is specified by a priority threshold value.

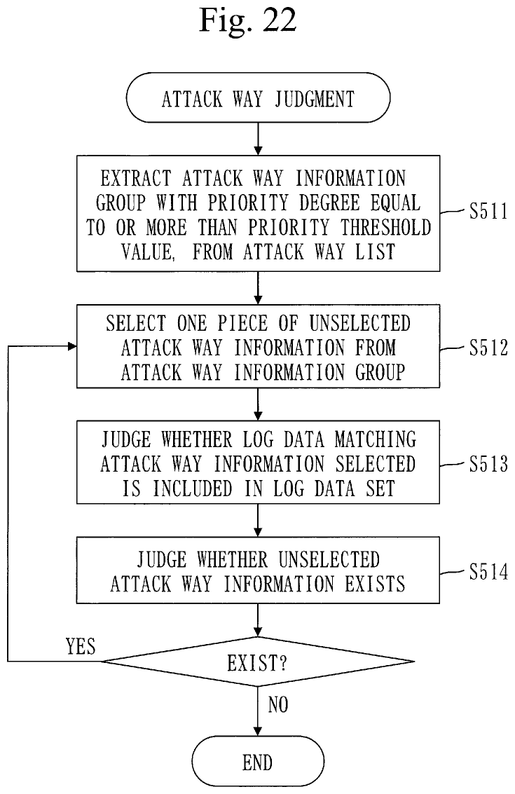

Attack way judgment by the attack judgment unit 120 will be described based on FIG. 22.

The attack way judgment by the attack judgment device 210 is the same as the attack way judgment by the attack judgment unit 120.

In a step S511, the attack judgment unit 120 extracts an attack way information group having a priority degree equal to or more than the priority threshold value, from an attack way list 191.

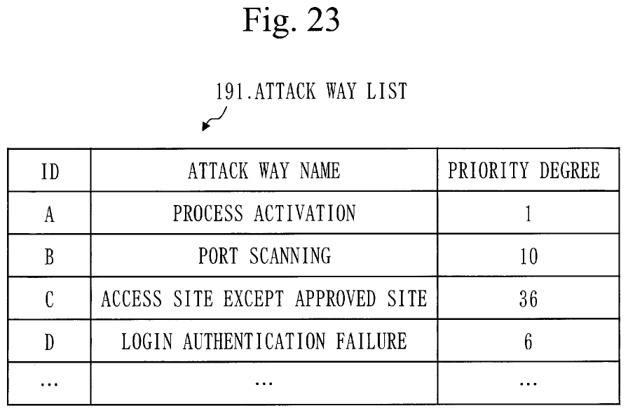

FIG. 23 illustrates a specific example of the attack way list 191.

The attack way list 191 includes one or more pieces of attack way information.

Each piece of the attack way information indicates an identifier (ID), an attack way name and a priority degree.

For example, when the priority threshold value is “8,” the attack judgment unit 120 extracts attack way information with ID “B” and attack way information with ID “C”, etc. from the attack way list 191.

Returning to FIG. 22, explanation will be continued from a step S512.

In the step S512, the attack judgment unit 120 selects one piece of unselected attack way information from the attack way information group extracted.

In a step S513, the attack judgment unit 120 judges whether log data that matches the attack way information selected is included in the log data set.

The step S513 is the same as the step S112 in the first embodiment.

In a step S514, the attack judgment unit 120 judges whether unselected attack way information exists in the attack way information group extracted.

When the unselected attack way information exists, the processing proceeds to the step S512.

When the unselected attack way information does not exist, the attack way judgment ends.

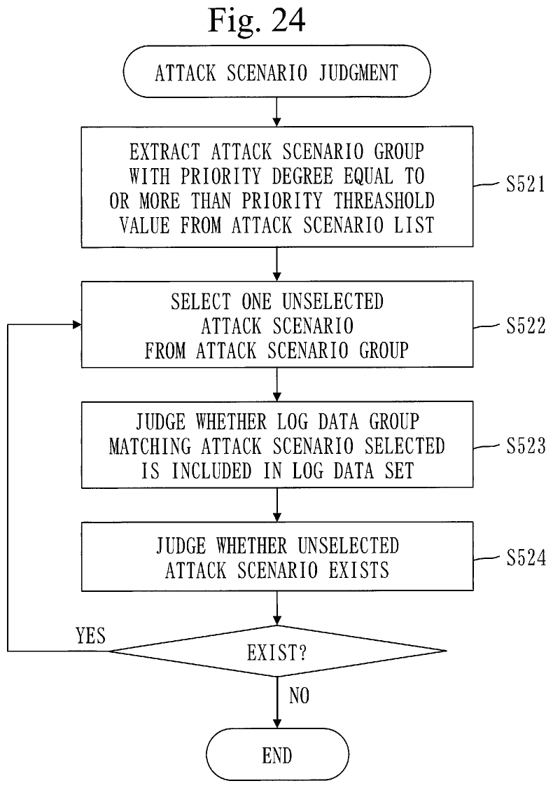

It will be described attack scenario judgment by the attack judgment unit 120 based on FIG. 24.

The attack scenario judgment by the attack judgment device 210 is the same as the attack scenario judgment by the attack judgment unit 120.

In a step S521, the attack judgment unit 120 extracts an attack scenario group having a priority degree equal to or more than a priority threshold value, from an attack scenario list 192.

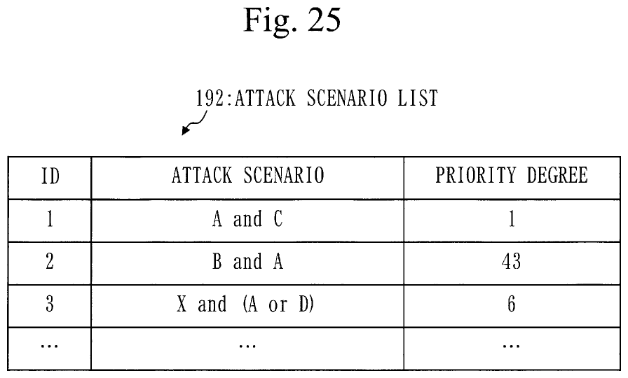

FIG. 25 illustrates a specific example of the attack scenario list 192.

The attack scenario list 192 includes one or more pieces of attack scenario information.

Each piece of attack scenario information indicates an identifier (ID), an attack scenario and a priority degree.

For example, when a priority threshold value is “8,” the attack judgment unit 120 extracts an attack scenario with ID “2,” etc. from the attack scenario list 192.

Returning to FIG. 24, explanation will be continued from a step S522.

In the step S522, the attack judgment unit 120 selects one unselected attack scenario from the attack scenario group extracted.

In a step S523, the attack judgment unit 120 judges whether a log data group that matches the attack scenario selected is included in the log data set.

The step S523 is the same as the step S122 in the first embodiment.

In a step S524, the attack judgment unit 120 judges whether an unselected attack scenario exists in the attack scenario group extracted.

When the unselected attack scenario exists, the processing proceeds to the step S522.

When the unselected attack scenario does not exist, the attack scenario judgment ends.

***Effect of Fifth Embodiment***

By the fifth embodiment, it is possible to control a judgment content in consideration of a system status. Therefore, it is possible to continue at least a part of attack detection irrespective of a system status.

***Supplement to Fifth Embodiment***

Fifth embodiment may be performed in combination with the second embodiment. That is, in the fifth embodiment, the attack judgment request unit 114 may change a request destination of attack judgment in accordance with change in a transmission state.

***Supplement to Embodiment***

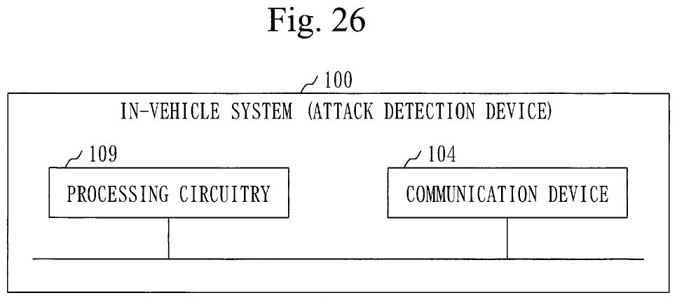

A hardware configuration of an attack detection device in the in-vehicle system 100 will be described based on FIG. 26.

The in-vehicle system 100 is equipped with a processing circuitry 109.

The processing circuitry 109 is a hardware component to realize the execution control unit 110, the attack judgment unit 120, the log acquisition unit 131 and the log management unit 132.

The processing circuitry 109 may be a dedicated hardware component, or may be the processor 101 that executes a program stored in the memory 102.

When the processing circuitry 109 is a dedicated hardware component, the processing circuitry 109 is, for example, a single circuit, a composite circuit, a processor that is made into a program, a processor that is made into a parallel program, an ASIC, and an FPGA, or a combination thereof.

ASIC is an abbreviation for “application specific integrated circuit.”

FPGA is an abbreviation for “field programmable gate array.”

The in-vehicle system 100 may be equipped with a plurality of processing circuits replacing the processing circuitry 109. The plurality of processing circuits share roles of the processing circuitry 109.

In the in-vehicle system 100, a partial function may be realized by a dedicated hardware component, and the rest function may be realized by software or firmware.

As seen above, the processing circuitry 109 may be realized by hardware, software or firmware, or a combination thereof.

The embodiments show examples of preferable embodiments, and the technical range of the present invention is not intended to be limited by the embodiments. The embodiments may be partially performed, or may be performed in combination with other embodiments. The procedure described with use of flowcharts, etc. may be changed appropriately.

“Unit” being an element of the in-vehicle system 100 may be replaced with “process” or “step.”

### REFERENCE SIGNS LIST

100: in-vehicle system; 101: processor; 102: memory; 103: auxiliary storage device; 104: communication device; 109: processing circuitry; 110: execution control unit; 111: log data set acquisition unit; 112: transmission state confirmation unit; 113: request destination determination unit; 114: attack judgment request unit; 115: judgment content determination unit; 116: system status confirmation unit; 120: attack judgment unit; 131: log acquisition unit; 132: log management unit; 190: storage unit; 191: attack way list; 192: attack scenario list; 200: attack detection system; 201: cloud; 202: external network; 210: attack judgment device; 220: vehicle

1. An attack detection device that is included in an embedded system, the attack detection device comprising:
processing circuitry to:
judge whether an attack against the embedded system exists;
confirm a transmission state of an external network;
determine, based on the transmission state of the external network, as a request destination of an attack judgment, either an attack judgment device that is provided outside the embedded system, to connect with the external network, or the attack judgment unit, and
request the attack judgment to the request destination determined.

2. The attack detection device as defined in claim 1, wherein
the processing circuitry confirms the transmission state of the external network, during the attack judgment;
judges, based on the transmission state of the external network, whether it is necessary to change the request destination of the attack judgment, during the attack judgment, and
changes the request destination of the attack judgment when it is judged necessary to change the request destination of the attack judgment.

3. The attack detection device as defined in claim 1, wherein
the processing circuitry determines, based on the transmission state of the external network, a judgment content being a content of the attack judgment, and
designates the judgment content determined and requests the attack judgment.

4. The attack detection device as defined in claim 3, wherein
the processing circuitry determines, as the judgment content, either a total judgment to perform a judgment for all of an attack scenario that is registered in an attack scenario list, or a partial judgment to perform a judgment for a part of the attack scenario that is registered in the attack scenario list.

5. The attack detection device as defined in claim 4, wherein
the processing circuitry further determines, as the judgment content, either a total judgment to perform a judgment for all of an attack way that is registered in an attack way list, or a partial judgment to perform a judgment for a part of the attack scenario that is registered in the attack way list.

6. The attack detection device as defined in claim 3, wherein
the processing circuitry confirms a status of the embedded system, and
determines the request destination of the attack judgment, based on the transmission state of the external network, and the status of the embedded system.

7. The attack detection device as defined in claim 6, wherein
the embedded system is an in-vehicle system that is mounted on a vehicle, and
the processing circuitry confirms a load status of the in-vehicle system and a traveling status of the vehicle.

8. The attack detection device as defined in claim 6, wherein
the processing circuitry determines the judgment content, based on the transmission state of the external network and the status of the embedded system.

9. The attack detection device as defined in claim 1, wherein
the processing circuitry confirms a status of the embedded system, and
determines the request destination of the attack judgment, based on the transmission state of the external network and a status of the embedded system.

10. A non-transitory computer readable medium storing an attack detection program in an embedded system, the attack detection program making a computer perform:
an attack judgment process to judge whether an attack against the embedded system exists;
a transmission state confirmation process to confirm a transmission state of an external network;
a request destination determination process to determine, based on the transmission state of the external network, as a request destination of an attack judgment, either an attack judgment device that is provided outside the embedded system, to connect with the external network, or the attack judgment process, and
an attack judgment request process to request the attack judgment to the request destination determined.
